(19) United States
(12) Patent Application Publication
(10) Pub. No.: US 2016/0269188 A1
(43) Pub. Date: Sep. 15, 2016

(54) REVERSE DIRECTED ACYCLIC GRAPH FOR MULTIPLE PATH REACHABILITY FROM ORIGIN TO IDENTIFIED DESTINATION VIA MULTIPLE TARGET DEVICES

(71) Applicant: Cisco Technology, Inc., San Jose, CA (US)

(72) Inventors: PASCAL THUBERT, La Colle Sur Loup (FR); PATRICK WETTERWALD, Mouans Sartoux (FR); JEAN-PHILIPPE VASSEUR, Saint Martin d'Uriage (FR); ERIC MICHEL LEVY-ABEGNOLI, Valbonne (FR)

(21) Appl. No.: 14/643,190

(22) Filed: Mar. 10, 2015

(51) Int. Cl. H04L 12/18; H04L 12/707

(52) U.S. Cl. CPC H04L 12/189; H04L 45/24

(57) ABSTRACT

In one embodiment, a method comprises: multicasting, by a wireless network device in a wireless network, a first message originated by the wireless network device and requesting reachability to an identified destination device via an identified target device class; generating, by the wireless network device, plural paths for reaching the identified destination device based on receiving destination advertisement messages having been originated by respective target devices belonging to the target device class; and pluricasting copies of a data packet to the identified destination device via the plural paths.

### TECHNICAL FIELD

The present disclosure generally relates to a reverse directed acyclic graph for multiple path reachability from an origin device to an identified destination via multiple target devices.

### BACKGROUND

This section describes approaches that could be employed, but are not necessarily approaches that have been previously conceived or employed. Hence, unless explicitly specified otherwise, any approaches described in this section are not prior art to the claims in this application, and any approaches described in this section are not admitted to be prior art by inclusion in this section.

A Low-power and Lossy Network (LLN) is a network that can include dozens or thousands of low-power router devices configured for routing data packets according to a routing protocol designed for such low power and lossy networks (RPL): such low-power router devices can be referred to as “RPL nodes”. Each RPL node in the LLN typically is constrained by processing power, memory, and energy (e.g., battery power); interconnecting links between the RPL nodes typically are constrained by high loss rates, low data rates, and instability with relatively low packet delivery rates. A network topology (a “RPL instance”) can be established based on creating routes toward a single “root” network device (e.g., a backbone router) in the form of a directed acyclic graph (DAG) toward the root network device, also referred to as a “DAG root”, where all routes in the LLN terminate at the DAG root.

Downward routes (i.e., away from the DAG root) can be created based on Destination Advertisement Object (DAO) messages that are created by a RPL node and propagated toward the DAG root. The RPL instance implements downward routes in the DAG of the LLN in either a storing mode only (fully stateful), or a non-storing mode only (fully source routed by the DAG root). In storing mode, a RPL node unicasts its DAO message to its parent node, such that RPL nodes store downward routing tables for their “sub-DAG” (the “child” nodes connected to the RPL node). In non-storing mode the RPL nodes do not store downward routing tables, hence a RPL node unicasts its DAO message to the DAG root, such that all data packets are sent to the DAG root and routed downward with source routes inserted by the DAG root.

The Internet Engineering Task Force (IETF) Request for Comments (RFC) 6997 also describes a reactive discovery of point-to-point routes in an LLN.

### BRIEF DESCRIPTION OF THE DRAWINGS

Reference is made to the attached drawings, wherein elements having the same reference numeral designations represent like elements throughout and wherein:

FIGS. 1A, 1B, and 1C summarize a wireless network device generating plural paths for pluricasting copies of a data packet to an identified destination device via respective border router devices belonging to a target device class requested by the wireless network device, according to an example embodiment.

FIG. 2 illustrates any one of the wireless network devices, the identified destination device, the border router devices, or the backbone routers of FIGS. 1A, 1B, and 1C, according to an example embodiment.

FIGS. 3A, 3B and 3C summarize a method of the wireless network device generating the plural paths of FIG. 1C based on the border routers responding to a request for reaching the identified destination device, according to an example embodiment.

### DESCRIPTION OF EXAMPLE EMBODIMENTS

### Overview

In one embodiment, a method comprises: multicasting, by a wireless network device in a wireless network, a first message originated by the wireless network device and requesting reachability to an identified destination device via an identified target device class; generating, by the wireless network device, plural paths for reaching the identified destination device based on receiving destination advertisement messages having been originated by respective target devices belonging to the target device class; and pluricasting copies of a data packet to the identified destination device via the plural paths.

In another embodiment, an apparatus comprises a device interface circuit and a processor circuit. The device interface circuit is configured for multicasting, into a wireless network, a first message requesting reachability to an identified destination device via an identified target device class. The device interface circuit further is configured for receiving destination advertisement messages having been originated by respective target devices belonging to the target device class. The processor circuit is configured for generating the first message. The processor circuit further is configured for generating plural paths for reaching the identified destination device via the target devices based on the destination advertisement messages. The processor circuit further is configured for causing the device interface circuit to pluricast copies of a data packet to the identified destination device via the plural paths.

In another embodiment, one or more non-transitory tangible media encoded with logic for execution by a machine and when executed by the machine operable for: multicasting, by a wireless network device in a wireless network, a first message originated by the wireless network device and requesting reachability to an identified destination device via an identified target device class; generating, by the wireless network device, plural paths for reaching the identified destination device based on receiving destination advertisement messages having been originated by respective target devices belonging to the target device class; and pluricasting copies of a data packet to the identified destination device via the plural paths.

In yet another embodiment, a method comprises: receiving, via a wireless data link by a border router device providing reachability to an identified destination device, a first message requesting reachability to the identified destination device via an identified target device class; generating, by the border router device in response to the first message, a destination advertisement message in response to the border router device belonging to the target device class; and outputting, by the border router device, the destination advertisement message via the wireless data link for delivery to an originator device of the first message, the destination advertisement specifying the identified destination device is reachable.

In another embodiment, an apparatus comprises a device interface circuit and a processor circuit. The device interface circuit is configured for receiving, via a wireless data link, a first message requesting reachability to the identified destination device via an identified target device class. The processor circuit is configured for generating, in response to the first message, a destination advertisement message in response to the apparatus, as a border router device, belonging to the target device class. The processor circuit further is configured for causing the device interface circuit to output the destination advertisement message via the wireless data link for delivery to an originator device of the first message, the destination advertisement specifying the identified destination device is reachable.

In another embodiment, one or more non-transitory tangible media encoded with logic for execution by a machine and when executed by the machine operable for: receiving, via a wireless data link by a border router device providing reachability to an identified destination device, a first message requesting reachability to the identified destination device via an identified target device class; generating, by the border router device in response to the first message, a destination advertisement message in response to the border router device belonging to the target device class; and outputting, by the border router device, the destination advertisement message via the wireless data link for delivery to an originator device of the first message, the destination advertisement specifying the identified destination device is reachable.

### DETAILED DESCRIPTION

Particular embodiments enable a wireless network device in a low-power and lossy network (LLN) to establish a pluricasting topology for reaching an identified destination device: the wireless network device can establish multiple paths for reaching the identified destination device via respective target devices belonging to a target device class specified by the wireless network device, based on the wireless network device effectively creating a “reverse” destination-oriented directed acyclic graph (DODAG) rooted at the wireless network device. In contrast to existing techniques for establishing a DODAG according to RPL, the wireless network device can serve as an origin device (i.e., an originator device) and multicast into the wireless LLN a request for reachability to an identified destination device: the request further requires the identified destination device is reachable via an identified target device class. The request, multicasted by the originator device, can be propagated throughout the LLN by other wireless network devices until received by a border router device belonging to the identified target class. The request is multicasted and propagated independent of any other DODAG rooted at the border router device.

The identified target class can refer to a specific type of border router device, for example a wired router having a wired connection for reaching the identified destination device; the identified target class also can refer to a more specific type of border router device, for example a “backbone router” in a realm-local scope with deterministic capabilities such as IPv6 Time Slotted Channel Hopping (6TiSCH). The request originated by the originator device also can specify additional constraints for any segment of the path between the originator device and the identified destination device (e.g., a wireless path segment and/or a wired path segment), including path latency constraints, deterministic reachability constraints, etc.

If a border router device determines that it does not belong to the target device class and/or cannot guarantee all of the specified constraints, the border router device can drop the request. If, however, the border router device belongs to the target device class and can guarantee all specified constraints, the border router device can respond to the request (received on a wireless link from a different wireless network device) by generating and outputting a destination advertisement message for delivery to the originator device, via the wireless link, specifying that the identified destination device is reachable.

Hence, the originator device can generate multiple paths for reaching the identified destination device based on receiving destination advertisement messages originated by plural target devices (e.g., border router devices) belonging to the target device class; a received destination advertisement message can identify multiple target devices, indicating that the corresponding path contains a wireless network device that can operate as a branch node that can reach at least two of the target devices. The originator device can optimize the multiple paths based on the received destination advertisement messages, and pluricast copies of a data packet to the identified destination device via the plural paths.

Hence, the originator device can build a “reverse DAG” for pluricasting copies of a data packet, to an identified destination device, via plural paths provided by respective border router devices belonging to the target device class. The border router devices can ensure that only a first copy of the data packet is sent to the identified destination device.

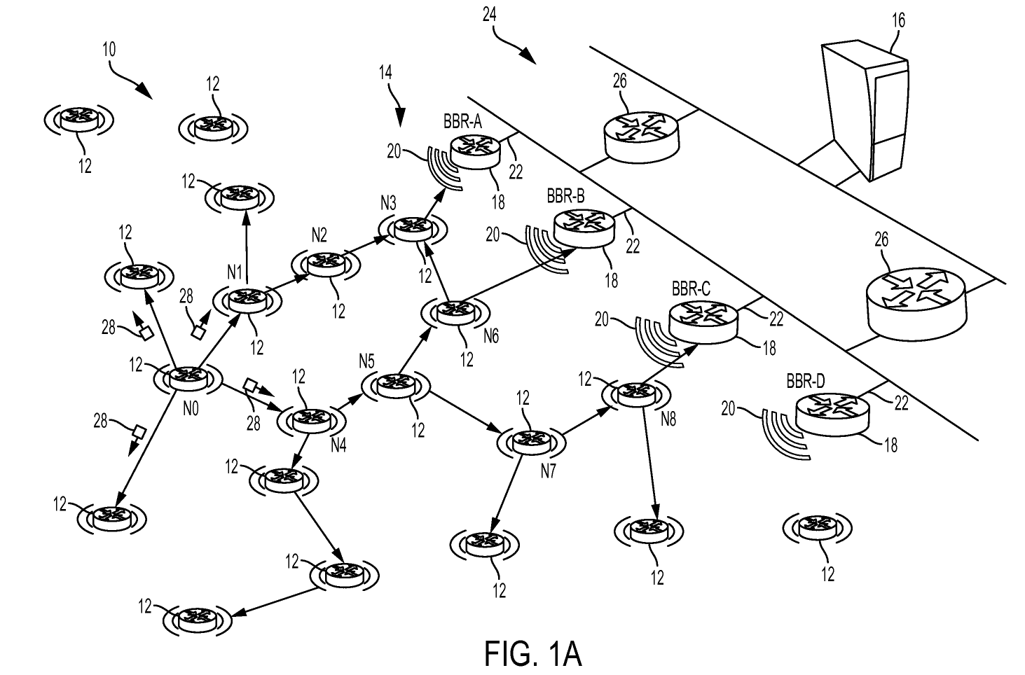

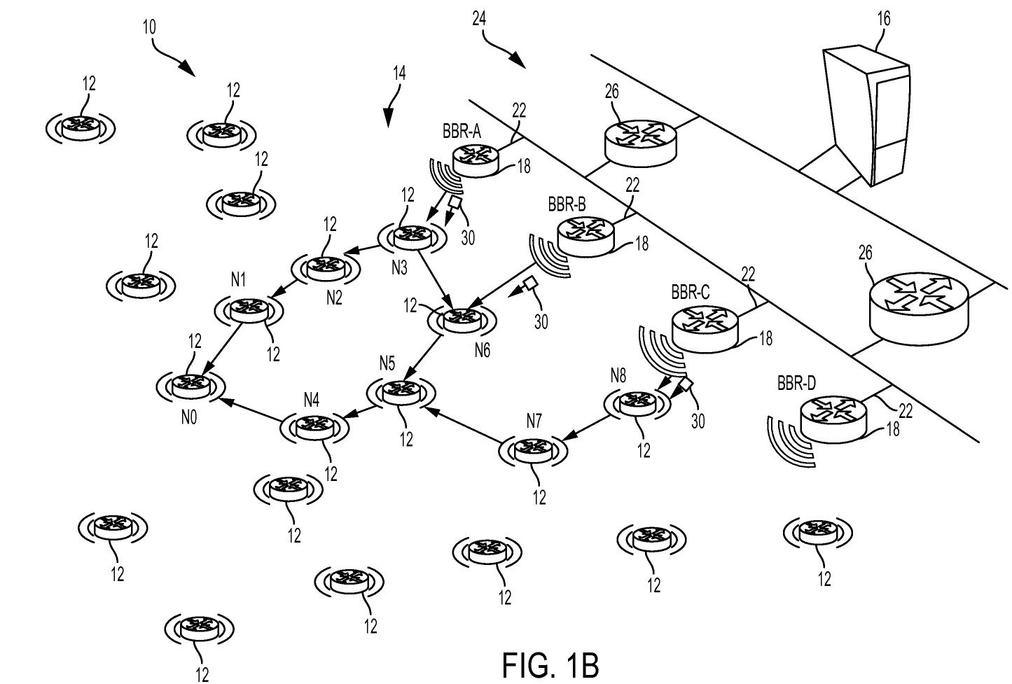

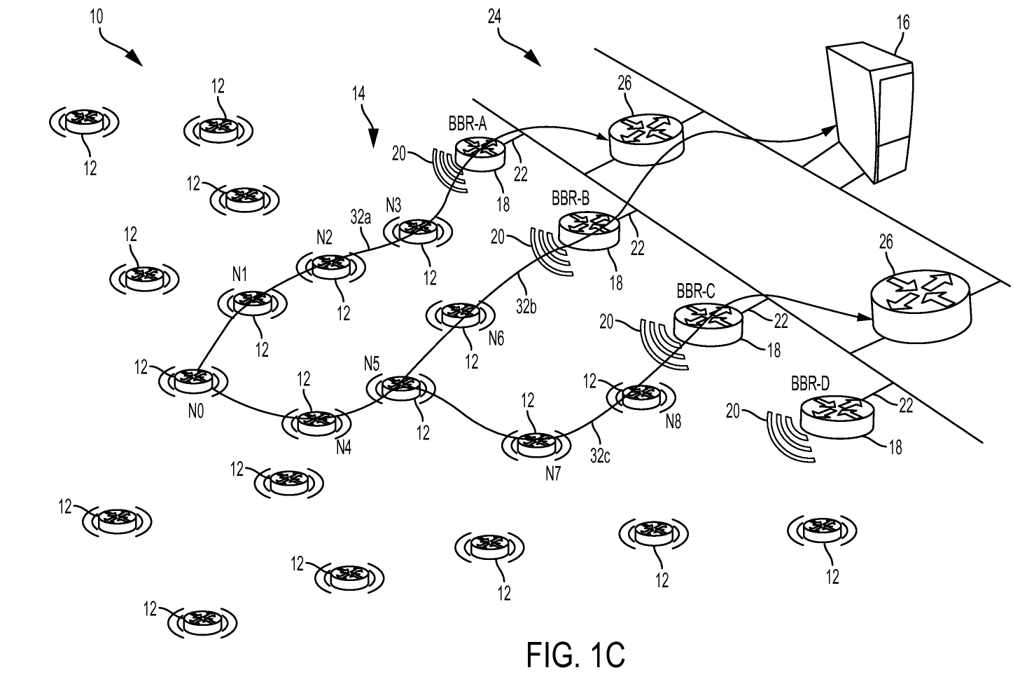

FIGS. 1A, 1B, and 1C illustrate an example network 10 having one or more wireless network devices 12 in an LLN 14 and configured for generating plural paths for reaching an identified destination device 16 via respective border router devices 18 belonging to a target device class, according to an example embodiment. Each border router device 18 provides a wireless connection 20 for the wireless network devices 12 and a wired connection 22 for reaching the identified destination device 16 via a backbone network 24. The identified destination device 16 can be a server device, for example a virtualization server device executing a virtual control logic such as a virtualized programmable logic controller (vPLC) application in an industrial network environment, etc. The backbone network 24 also can include backbone routers 26 for routing network traffic in the backbone network 24.

FIG. 1A illustrates a wireless network device 12 operating as an originator device “N0” 12 based on generating and multicasting a request message 28, also referred to as a wireless device information object (“WIO”) 28, requesting reachability to the identified destination device 16 via an identified target device class. The originator device “N0” 12 can multicast the WIO 28 using a link-local multicast address, for example as described in Section 20.19 of RFC 6550, causing the other wireless network devices 12 to multicast the WIO 28 throughout the LLN 14. As described in further detail below, the WIO 28 enables each border router device 18 to generate a border router destination advertisement object message (“BBR-DAO”) 30, illustrated in FIG. 1B, specifying that the identified destination device 16 is reachable. In response to the originator device “N0” 12 receiving the BBR-DAO 30 originated by each border router device 18 via the wireless network devices 12, the originator device “N0” 12 can generate plural paths 32a, 32b, and 32c, illustrated in FIG. 1C, for pluricasting copies of a data packet to the identified destination device 16 via the plural paths 32a, 32b, and 32c reaching the border routers “BBR-A”, “BBR-B”, and “BBR-C” 18, respectively.

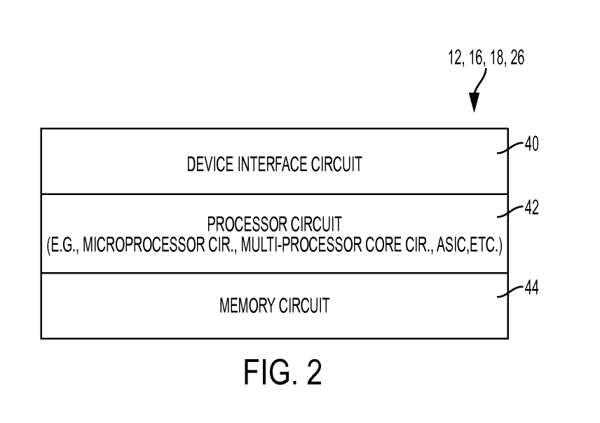

FIG. 2 illustrates any one of the wireless network device 12, the identified destination device 16, the border router devices 18 or the backbone routers 26, according to an example embodiment. Each apparatus 12, 16, 18 and 26 is a physical machine (i.e., a hardware device) configured for implementing network communications with other physical machines via the network 10. The term “configured for” or “configured to” as used herein with respect to a specified operation refers to a device and/or machine that is physically constructed and arranged to perform the specified operation.

Each apparatus 12, 16, 18 and 26 can include a device interface circuit 40, a processor circuit 42, and a memory circuit 44. The device interface circuit 40 can include one or more distinct physical layer transceivers for communication with any one of the other devices 12, 16, 18 and 26; for example, the device interface circuit 40 of each wireless network device 12 can include a Wi-Fi transceiver and/or wireless transceiver for deterministic communications, for example according to 6TiSCH; the device interface circuit 40 of the identified destination device 16 and the backbone router 26 can include a wired IEEE based Ethernet transceiver for communications via the backbone network 24; the device interface circuit 40 of the border router device 18 can include a wireless transceiver for communication with the wireless network devices 12 of the LLN 14, and a wired transceiver for communication with each backbone router 26 and the identified destination device 16 via the backbone network 24. The processor circuit 42 can be configured for executing any of the operations described herein, and the memory circuit 44 can be configured for storing any data or data packets as described herein, including source route paths, route table entries in storing mode, etc.

Any of the disclosed circuits of the devices 12, 16, 18 and 26 (including the device interface circuit 40, the processor circuit 42, the memory circuit 44, and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown) and implemented using one or more integrated circuits, where execution of executable code stored in an internal memory circuit (e.g., within the memory circuit 44) causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 44 can be implemented, for example, using a non-volatile memory such as a programmable read only memory (PROM) or an EPROM, and/or a volatile memory such as a DRAM, etc.

Further, any reference to “outputting a message” or “outputting a packet” (or the like) can be implemented based on creating the message/packet in the form of a data structure and storing that data structure in a non-transitory tangible memory medium in the disclosed apparatus (e.g., in a transmit buffer). Any reference to “outputting a message” or “outputting a packet” (or the like) also can include electrically transmitting (e.g., via wired electric current or wireless electric field, as appropriate) the message/packet stored in the non-transitory tangible memory medium to another network node via a communications medium (e.g., a wired or wireless link, as appropriate) (optical transmission also can be used, as appropriate). Similarly, any reference to “receiving a message” or “receiving a packet” (or the like) can be implemented based on the disclosed apparatus detecting the electrical (or optical) transmission of the message/packet on the communications medium, and storing the detected transmission as a data structure in a non-transitory tangible memory medium in the disclosed apparatus (e.g., in a receive buffer). Also note that the memory circuit 44 can be implemented dynamically by the processor circuit 42, for example based on memory address assignment and partitioning executed by the processor circuit 42.

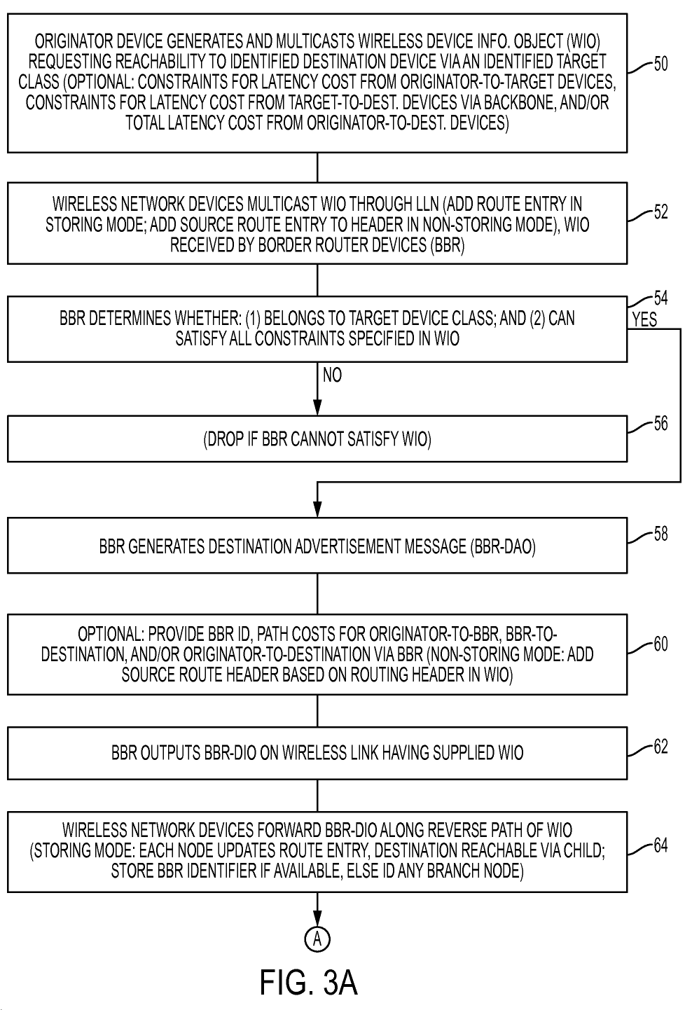

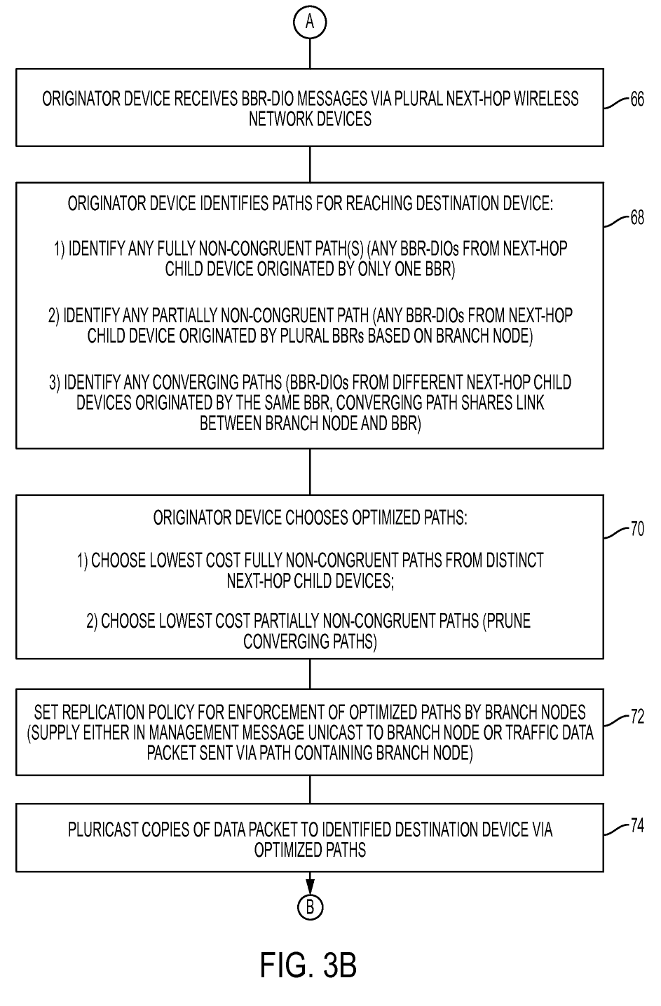

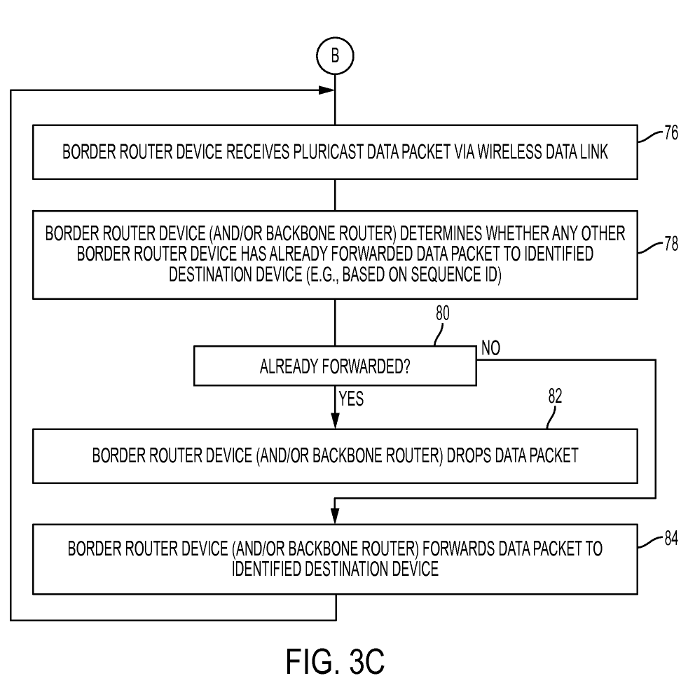

FIGS. 3A, 3B and 3C illustrate a method of the originator device “N0” 12 generating the plural paths 32a, 32b, and 32c for pluricasting a data packet based on the border routers 18 responding to a request 28 for reaching the identified destination device 16, according to an example embodiment. The operations described with respect to any of the Figures can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.). Hence, one or more non-transitory tangible media can be encoded with logic for execution by a machine, and when executed by the machine operable for the operations described herein.

In addition, the operations described with respect to any of the Figures can be performed in any suitable order, or at least some of the operations in parallel. Execution of the operations as described herein is by way of illustration only; as such, the operations do not necessarily need to be executed by the machine-based hardware components as described herein; to the contrary, other machine-based hardware components can be used to execute the disclosed operations in any appropriate order, or at least some of the operations in parallel.

Referring to FIG. 3A, the processor circuit 42 of the originator device “N0” 12 is configured for generating in operation 50 a WIO 28 requesting reachability to the identified destination device 16 via an identified target class. The identified destination device 16 can be identified by a prescribed identifier known by the originator device “N0” 12, for example a unique IPv6 unicast address, a unique host name that can be resolved by the originator device “N0” 12, etc. The target device class specified in the WIO 28 is not a unicast IP address, rather the target device class defines a specific class of network devices with prescribed capabilities, for example “all border routers having a wired connection to the backbone network”, or “all backbone routers in a realm-local scope with deterministic capabilities”. In one embodiment, the target device class can be identified by a prescribed multicast address reserved exclusively for only the target network devices belonging to the target device class defined by the originator device “N0” 12.

The processor circuit 42 of the originator device “N0” 12 also is configured for specifying, in the WIO 28, constraints for any segment of the path between the originator device “N0” 12 and the identified destination device 16 (e.g., a wireless path segment and/or a wired path segment), including path latency constraints, deterministic reachability constraints (e.g., 6TiSCH), etc. For example, the processor circuit 42 of the originator device “N0” 12 is configured for specifying, as the constraints, a first latency cost for transmission of a data packet from the originator device “N0” 12 to the corresponding target device (e.g., border router device “BBR-A” 18), a second latency cost for transmission of the data packet from the corresponding target device to the identified destination device 16 via the backbone network 24, or a total latency cost for transmission of the data packet from the originator device “N0” 12 to the identified destination device 16 via the corresponding target device (e.g., border router device “BBR-A” 18). The device interface circuit 40 of the originator device “N0” 12 is configured for multicasting the WIO 28 to adjacent wireless network devices 28 in operation 50 in an attempt to reach the border routers 18.

The multicasting of the WIO 28 causes the wireless network devices 12 in operation 52 to multicast the WIO 28 throughout the LLN 14. As illustrated in FIG. 1A, the multicasting of the WIO 28 causes the wireless network devices “N1”, “N2”, “N3” 12 to forward a copy the WIO 28 to the border router “BBR-A” 18; the multicasting of the WIO 28 also causes the wireless network devices “N4”, “N5”, “N6” to forward a copy of the WIO 28 to the border router “BBR-B” 18. The wireless network device “N5” 12 can multicast the WIO 28 to the wireless network device “N7” 12 in addition to the wireless network device “N6” 12, and the wireless network device “N6” can multicast the WIO 28 to the wireless network device “N3” in addition to the border router device “BBR-B” 18; hence, the wireless network devices “N7” and “N8” 12 can forward the WIO 28 to the border router “BBR-C” 18.

Hence, in operation 52 the device interface circuit 40 of the border router device “BBR-A” 18 can receive a WIO 28 from the originator device “N0” 12 via a first path formed by the sequence of wireless network devices N1-N2-N3 and another WIO 28 from the originator device “N0” 12 via a second path formed by the sequence of wireless network devices N4-N5-N6-N3, where both the first and second paths share the wireless data link between the wireless network device “N3” 12 and the border router device “BBR-A” 18. The device interface circuit 40 of the border router device “BBR-B” 18 in operation 52 can receive a WIO 28 from the originator device “N0” 12 via a third path formed by the sequence of wireless network devices N4-N5-N6. The device interface circuit 40 of the border router device “BBR-C” 18 can receive a WIO 28 from the originator device “N0” 12 via a fourth path formed by the sequence of wireless network devices N4-N5-N7-N8.

As illustrated in operation 52 of FIG. 3A, the paths formed by the sequences of wireless network devices 12 can be established in a storing mode (e.g., based on each wireless network device 12 creating a local route entry (in its memory circuit 44) identifying the originator device “N0” 12 associated with the WIO 28 and the corresponding “parent” device 12 having transmitted the WIO 28). The paths formed by the sequences of wireless network devices also can be established in a non-storing mode in operation 52, where each wireless network device 12 in the sequence adds its network address (e.g., IPv6 address) to a routing header (e.g., a source routing header or reverse routing header) that enables the border router device 18 to send a border router destination advertisement object message (“BBR-DAO”) (i.e., destination advertisement message) 30 that includes a source routing header for reaching the originator device “N0” 12.

As described in further detail below, the wireless network devices “N5” and “N6” 12 can be identified as branch nodes because they each have two paths for reaching two or more different border routers 18, although the second path of the wireless network device “N6” 12 will be pruned later to prevent formation of a convergent path that shares a link with another path (e.g., the link between the wireless network device “N3” and the border router device “BBR-A” 18).

FIG. 1B illustrates each of the border router devices 18 outputting a corresponding destination advertisement message (i.e., border router destination advertisement object message “BBR-DAO”) 30 responsive to reception of the WIO 28, according to an example embodiment. The processor circuit 42 of each border router device 18 is configured for selectively responding in operation 54 of FIG. 3A to the WIO 28 based on determining that the corresponding border router device 18 belongs to a target device class specified in the WIO 28, and based on determining that the border router device 18 can guarantee any constraint specified in the WIO 28.

If the processor circuit 42 of a border router device 18 determines that the border router device 18 is a member of the target device class specified in the WIO 28 and can guarantee the constraints specified in the WIO 28, the border router device 18 can respond by the processor circuit 42 generating in operation 58 a BBR-DAO 30 specifying that the identified destination device 16 is reachable. If desired, the processor circuit 42 of the border router device 18 in operation 60 also can insert into the BBR-DAO 30 a border router device identifier (BBR ID) indicating that the identified destination device 16 is reachable via the specific border router device 18, including for example an identifier for the specific border router device 18 (e.g., a unique unicast IP address or other unique border router identifier such as “BBR-A”, etc.). The processor circuit 42 of the border router device 18 also is configured for inserting in operation 60, into the BBR-DAO 30, first path metrics (e.g., jitter, latency, deterministic properties, etc.) describing propagation characteristics of a path of the WIO 28 from the originator device “N0” 12 to the border router device 18 via the wireless LLN 14, or second path metrics (e.g., jitter, latency, deterministic properties, etc.) describing propagation characteristics for the border router device 18 reaching the identified destination device 16 via the backbone network 16.

If the LLN 14 is operating in non-storing mode, the processor circuit 42 of the border router device 18 in operation 60 can insert into the BBR-DAO 30 the source route based on the received WIO 28; hence, the device interface circuit 40 of the border router device “BBR-A” 18 is configured for outputting in operation 62 a first BBR-DAO 30 specifying the source route N3-N2-N1-N0, and a second BBR-DAO 30 specifying the source route N3-N6-N5-N4-N0; the device interface circuit 40 of the border router device “BBR-B” 18 can output a BBR-DAO 30 specifying the source route N6-N5-N4-N0; and the device interface circuit 40 of the border router device “BBR-C” 18 can output a BBR-DAO 30 specifying the source route N8-N7-N5-N4-N0.

Each wireless network device 12 in operation 64 can forward a received BBR-DAO 30 along the reverse path relative to the WIO 28. If the LLN 14 is operating in storing mode, each wireless network device 12 receiving the BBR-DAO 30 can update its internal route entry (stored in its memory circuit 44) specifying that the identified destination device 16 is reachable via the corresponding child device having transmitted the BBR-DAO 30; hence, the wireless network device “N3” 12 can update its internal route entry (stored in its memory circuit 44) specifying that the identified destination device 16 (identifiable by its unique IPv6 unicast address) is reachable via the border router device “BBR-A” 18; the wireless network device “N2” 12 can update its internal route entry (stored in its memory circuit 44) specifying that the identified destination device 16 is reachable via the wireless network device “N3” 12; the wireless network device “N1” 12 can update its internal route entry (stored in its memory circuit 44) specifying that the identified destination device 16 is reachable via the wireless network device “N2” 12; and the “N0” can update its internal route entry (stored in its memory circuit 44) specifying that the identified destination device 16 is reachable via the wireless network device “N1” 12.

Since the wireless network device “N6” 12 and wireless network device “N5” 12 are branch nodes, the branch nodes in storing mode can aggregate multiple received BBR-DAOs 30. If the BBR-DAO 30 specifies the identifier for the corresponding border router device 18, the branch node can include the identifiers within the aggregated BBR-DAO 30. Hence, the wireless network device “N6” 12 can output to the wireless network device “N5” 12 an aggregated BBR-DAO 30 specifying that the identified destination device 16 is reachable via border router device “BBR-A” 18 or border router device “BBR-B” 18, causing the wireless network device “N5” 12 to add an internal route entry (stored in its memory circuit 44) specifying that the border router device “BBR-A” 18 and the border router device “BBR-B” 18 provide reachability to the identified destination device 16 via the wireless network device “N6” 12. The wireless network device “N5” 12 can output to the wireless network device “N4” 12 an updated BBR-DAO 30 specifying that the identified destination device 16 is reachable via the border router device “BBR-A” 18, the border router device “BBR-B” 18, or the border router device “BBR-C” 18 (based on the BBR-DAO 30 received from the wireless network device “N7” 12), causing the wireless network device “N4” 12 to add an internal route entry (stored in its memory circuit 44) specifying that the border router device “BBR-A” 18, the border router device “BBR-B” 18, and the border router device “BBR-C” 18 provide reachability to the identified destination device 16 via the wireless network device “N5” 12.

The wireless network device “N4” 12 can output an updated BBR-DAO 30 to the originator device “N0” 12 specifying that the identified destination device 16 is reachable via the border router device “BBR-A” 18, the border router device “BBR-B” 18, or the border router device “BBR-C” 18, causing the originator device “N0” 12 to add an internal route entry (stored in its memory circuit 44) specifying that the border router device “BBR-A” 18, the border router device “BBR-B” 18, and the border router device “BBR-C” 18 provide reachability to the identified destination device 16 via the wireless network device “N4” 12.

Hence, the device interface circuit 40 of the originator device “N0” 12 is configured for receiving the BBR-DAOs 30 in operation 66 of FIG. 3B from the next-hop child network devices “N1” 12 and “N4” 12. The received BBR-DAOs 30 (stored in the memory circuit 44 of the originator device “N0” 12) enable the processor circuit 42 of the originator device “N0” 12 in operation 68 to generate plural paths (32a, 32b, and 32c of FIG. 1C) for reaching the identified destination device 16 via the respective border routers “BBR-A”, “BBR-B”, and “BBR-C” 18.

The processor circuit 42 of the originator device “N0” 12 can determine in operation 68 the availability of a fully non-congruent path having no shared links (e.g., 32a), a partially non-congruent path (e.g., 32b or 32c) having at least one shared link (e.g., N4-N5) and a branch node (e.g., wireless network device “N5” 12) that can reach at least two of the target devices (e.g., border router device “BBR-B” 18 and border router device “BBR-C” 18), or a convergent path, described below. For example, the processor circuit 42 of the originator device “N0” 12 is configured for detecting the presence of one or more branch nodes in any path to a border router device 18 to identify any fully non-congruent path (e.g., 32a).

As illustrated in FIG. 1B, in non-storing mode the BBR-DAO 30 received from the next-hop child device N1 12 would specify only a source route path of BBR-A-N3-N2-N1-N0, enabling the processor circuit 42 of the originator device “N0” 12 to determine that the next-hop child device N1 12 provides a fully non-congruent path 32a for reaching the border router device “BBR-A” 18; in contrast, the originator device “N0” 12 can receive from the next hop child device N4 12 a BBR-DAO 30 specifying a source route path of BBR-B-N6-N5-N4-N0, and another BBR-DAO 30 specifying a different source route path of BBR-C-N8-N7-N5-N4-N0, enabling the processor circuit 42 of the originator device “N0” 12 to determine the next-hop child device N4 12 provides partially non-congruent paths 32b and 32c based on a shared link “N4-N5” and a branch node “N5” that can reach border router device “BBR-B” 18 and border router device “BBR-C” 18.

The processor circuit 42 of the originator device “N0” 12 in operation 68 also can identify a convergent path, for example in response to receiving from the next-hop child device N4 12 another BBR-DAO 30 specifying the source route path BBR-A-N3-N6-N5-N4-N0. In this case the processor circuit 42 can identify determine the convergent path BBR-A-N3-N6-N5-N4-N0 shares a link “BBR-A-N3” that exists between the branch node “N5” downstream of the next-hop child device N4 12, and the border router device “BBR-A” 18 having the fully non-congruent path 32a via the other next-hop child device N1 12. Hence, the processor circuit 42 of the originator device “N0” 12 is configured for pruning in operation 70 the convergent path BBR-A-N3-N6-N5-N4-N0.

The processor circuit 42 of the originator device “N0” 12 also can identify a fully non-congruent path (e.g., 32a) in storing mode in operation 68 based on the BBR-DAO 30 specifying a first and only the first of the border routers 18 (e.g., only border router device “BBR-A” 18 is specified in the BBR-DAO 30 from the wireless network device “N1” 12). In storing mode the partially non-congruent paths (e.g., 32b and 32c) can be identified by the processor circuit 42 based on multiple identifiers for the border router device “BBR-B” 18 and the border router device “BBR-C” 18 in the BBR-DAO 30 from the wireless network device “N4” 12. In storing mode the partially non-congruent paths (e.g., 32b and 32c) also can be identified in response to the wireless network device “N5” 12 inserting into the BBR-DAO 30 a branch identifier that enables the originator device “N0” 12 to identify (implicitly or explicitly) the presence of a branch node downstream of the wireless network device “N4” 12.

In response to identification of any fully non-congruent paths and/or any partially non-congruent paths, the processor circuit 42 of the originator device “N0” 12 in operation 70 can choose the optimized paths 32a, 32b, and 32c based on a prioritized comparison of the non-congruency of paths relative to the associated costs for reaching the border router device 18 and/or the identified destination device 16 via the border router device 18. For example, choose the lowest cost fully non-congruent paths from distinct next-hop child devices 12, followed by choosing the lowest cost partially non-congruent paths having a branch node. As described previously, converging paths (e.g., BBR-A-N3-N6-N5-N4-N0) are pruned to prevent congestion on the wireless data link “BBR-A-N3” of the border router device 18.

The processor circuit 42 of the originator device “N0” 12 is configured for setting in operation 72 a replication policy for one or more partially non-congruent paths (e.g., 32b) to limit replication of a data packet by a branch node (e.g., N6 12) among the border router device “BBR-A” 18 and the border router device “BBR-B” 18 reachable by the branch node “N6” 12. In particular, the processor circuit 42 can set a replication policy that permits a limited number of replications; for example, the processor circuit 42 of the originator device “N0” 12 can set a fanout counter (e.g., a bit mask) that is decremented by each branch node along a path 32b: if the fanout counter is set by the processor circuit 42 of the originator device “N0” 12 to “1”, then only the wireless network device “N5” 12 is permitted to replicate the data packet to its next-hop child devices N6 12 and N7 12 along the downstream paths 32b and 32c. In response to the wireless network device “N5” 12 decrementing the fanout counter, the wireless network device “N6” 12 will detect the fanout counter equal to zero, preventing the wireless network device “N6” 12 from replicating the data packet to the wireless network device “N3” 12; hence the wireless network device “N6” 12 will forward the data packet either according to the explicit source route (in non-storing mode), according to the stored route table in its memory circuit 44 (in storing mode), or according to a default route for reaching its border router 18, namely border router device “BBR-B” 18.

As illustrated in FIG. 3B, the processor circuit 42 of the originator device “N0” 12 can cause the device interface circuit 40 to supply the replication policy in the corresponding copy of the data packet output onto the path 32b via the wireless network device “N4” 12; alternately, the processor circuit 42 of the originator device “N0” 12 can cause the device interface circuit 40 to send a message onto the path 32b (e.g., a management message unicast to the branch node “N5” and/or “N6” 12) specifying the replication policy.

The processor circuit 42 of the originator device “N0” 12 in operation 74 can cause the device interface circuit 40 to pluricast copies of a data packet to the identified destination device 16 via the plural paths 32a, 32b, and 32c. As described previously, the data packet can be pluricast in non-storing mode based on specifying the explicit source-route path for each of the paths 32a, 32b, and 32c, or based on a modified source-route path identifying the branch node N5 (e.g., N4-N5—Branch1-N6-BBR-B—Branch2-N7-N8-BBR-C); alternately, the data packet can be pluricast in storing mode based on the network devices 12 along the paths 32a, 32b, and 32c having added route table entries based on the WIO 28 and the responsive BBR-DAOs 30.

FIG. 3C illustrates an optional operation that can eliminate duplicate packet transmission to the identified destination device 16. Referring to FIG. 3C, the device interface circuit 40 of a border router device 18 and/or a backbone router 26 is configured for receiving a pluricast data packet in operation 76. The processor circuit 42 of the border router device 18 and/or backbone router 26 can be configured for determining in operation 78 whether any other border router device 18 and/or backbone router 26 has already forwarded a copy of the data packet to the identified destination device 16, for example based on comparing sequence identifiers of a data flow identified by the source address of the originator device “N0” 12 and the destination address of the identified destination device 16.

The processor circuit 42 is configured for selectively causing the device interface circuit 40 forward the data packet to the identified destination device 16, via the backbone network 24, based on a determined absence of any other border router device 18 and/or backbone router 26 having already forwarded the data packet to the identified destination device 16. Hence, if in operation 80 the processor circuit 42 of the border router device 18 and/or the backbone router 26 determines the data packet has already been forwarded to the identified destination device 16 via the backbone network 24, the processor circuit 42 can be configured for dropping the data packet in operation 82. If, however, the processor circuit 42 determines in operation 80 that the data packet has not yet been forwarded to the identified destination device 16, the processor circuit 42 of the border router device 18 and/or the backbone router 26 causes the device interface circuit 40 to forward the data packet in operation 84 to the identified destination device 16. As illustrated in FIG. 1C, the data packet sent along path 32b is forwarded to the identified destination device 16 via the backbone network 24, whereas the copies of the data packet sent along the paths 32a and 32c optionally can be dropped by the border router device “BBR-A” 18 and border router device “BBR-C” 18, or alternatively by the backbone routers 26.

Alternatively, each of the border router devices 18 and the backbone routers 26 can be configured to forward all copies of the data packet to the destination device 16 to further ensure reception reliability; in this case, the identified destination device 16 can execute the elimination process illustrated in FIG. 3C. Other techniques can be used for implementing the replication and elimination process in FIG. 3C.

According to example embodiments, a wireless network device in a low-power and lossy network can generate a pluricast topology having multiple paths for reaching an identified destination device via multiple border router devices belonging to an identified target device class set by the wireless network device, based on generating a “reverse DAG” to the border router devices providing reachability to the identified destination device. Since the “reverse DAG” is based on the multiple border router devices providing reachability to the identified destination device (according to the constraints of the target device class), other routing topologies can be used in conjunction with the “reverse DAG” to optimize routing to the identified destination device 16. For example, the identified destination device 16 can build its own DODAG (rooted at the identified destination device 16) according to RFC 6550, enabling the border routers 18 (as leaves of the DODAG) to have non-overlapping paths for reaching the identified destination device 16 via the DODAG rooted at the identified destination device 16. The example embodiments also bypass existing techniques for building a DODAG according to RPL which would build the DODAG rooted at the border router.

The example embodiments also enable a wireless network device to generate a single DAG for a constrained flow, enabling the wireless network device to select any necessary constraints for establishment of a pluricast topology with minimal signaling.

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
multicasting, by a wireless network device in a wireless network, a first message originated by the wireless network device and requesting reachability to an identified destination device via an identified target device class;
generating, by the wireless network device, plural paths for reaching the identified destination device based on receiving destination advertisement messages having been originated by respective target devices belonging to the target device class; and
pluricasting copies of a data packet to the identified destination device via the plural paths.

2. The method of claim 1, further comprising:
the wireless network device specifying, in the first message, one or more constraints required for each target device of the target device class, including at least one of a first latency cost for transmission of a data packet from the wireless network device to the corresponding target device, a second latency cost for transmission of the data packet from the corresponding target device to the identified destination device via a backbone network, or a total latency cost for transmission of the data packet from the wireless network device to the identified destination device via the corresponding target device;
each destination advertisement message indicating the corresponding target device can guarantee the one or more constraints.

3. The method of claim 1, wherein:
the generating includes any one of identifying whether any one of the paths is a fully non-congruent path having no shared links based on whether any destination advertisement message indicates origination by a first and only the first of the target devices, or identifying whether any one of the paths is a partially non-congruent path having at least one shared link and a branch node that can reach at least two of the target devices;
the generating further including selectively generating a first path based on a determined availability of a first fully non-congruent path for reaching the first target device, and generating a second path based on at least one of a determined availability of a second fully non-congruent path for reaching a second of the target devices or selection of one of the partially non-congruent paths for reaching the second target device via the branch node.

4. The method of claim 3, wherein the generating further includes pruning any convergent paths sharing a link between the branch node and a corresponding one of the target devices.

5. The method of claim 1, further comprising the wireless network device setting a replication policy for a first of the paths, the replication policy causing a branch node along the first path to limit replication of the data packet among multiple target devices reachable by the branch node.

6. The method of claim 5, wherein the replication policy is output along the first path based on at least one of:
supplying the replication policy in one of the corresponding copy of the data packet output onto the first path; or
sending a second message specifying the replication policy, distinct from the copies of the data packet, onto the first path.

7. An apparatus comprising
a device interface circuit configured for multicasting, into a wireless network, a first message requesting reachability to an identified destination device via an identified target device class, the device interface circuit further configured for receiving destination advertisement messages having been originated by respective target devices belonging to the target device class; and
a processor circuit configured for generating the first message, the processor circuit further configured for generating plural paths for reaching the identified destination device via the target devices based on the destination advertisement messages, the processor circuit further configured for causing the device interface circuit to pluricast copies of a data packet to the identified destination device via the plural paths.

8. The apparatus of claim 7, wherein:
the processor circuit is configured for specifying, in the first message, one or more constraints required for each target device of the target device class, including at least one of a first latency cost for transmission of a data packet from the apparatus to the corresponding target device, a second latency cost for transmission of the data packet from the corresponding target device to the identified destination device via a backbone network, or a total latency cost for transmission of the data packet from the apparatus to the identified destination device via the corresponding target device;
each destination advertisement message indicating the corresponding target device can guarantee the one or more constraints.

9. The apparatus of claim 7, wherein the processor circuit further is configured for:
identifying whether any one of the paths is a fully non-congruent path having no shared links based on whether any destination advertisement message indicates origination by a first and only the first of the target devices, or identifying whether any one of the paths is a partially non-congruent path having at least one shared link and a branch node that can reach at least two of the target devices;
selectively generating a first path based on a determined availability of a first fully non-congruent path for reaching the first target device, and generating a second path based on at least one of a determined availability of a second fully non-congruent path for reaching a second of the target devices or selection of one of the partially non-congruent paths for reaching the second target device via the branch node.

10. The apparatus of claim 9, wherein the processor circuit further is configured for pruning any convergent paths sharing a link between the branch node and a corresponding one of the target devices.

11. The apparatus of claim 7, wherein the processor circuit is configured for setting a replication policy for a first of the paths, the replication policy causing a branch node along the first path to limit replication of the data packet among multiple target devices reachable by the branch node.

12. The apparatus of claim 11, wherein the processor circuit is configured for causing the device interface circuit to output the replication policy along the first path based on at least one of:
supplying the replication policy in one of the corresponding copy of the data packet output onto the first path; or
sending a second message specifying the replication policy, distinct from the copies of the data packet, onto the first path.

13. One or more non-transitory tangible media encoded with logic for execution by a machine and when executed by the machine operable for:
multicasting, by a wireless network device in a wireless network, a first message originated by the wireless network device and requesting reachability to an identified destination device via an identified target device class;
generating, by the wireless network device, plural paths for reaching the identified destination device based on receiving destination advertisement messages having been originated by respective target devices belonging to the target device class; and
pluricasting copies of a data packet to the identified destination device via the plural paths.

14. A method comprising:
receiving, via a wireless data link by a border router device providing reachability to an identified destination device, a first message requesting reachability to the identified destination device via an identified target device class;
generating, by the border router device in response to the first message, a destination advertisement message in response to the border router device belonging to the target device class; and
outputting, by the border router device, the destination advertisement message via the wireless data link for delivery to an originator device of the first message, the destination advertisement specifying the identified destination device is reachable.

15. The method of claim 14, wherein:
the first message further specifies one or more constraints required for a target device of the target device class, including at least one of a first latency cost for transmission of a data packet from the originator device to the target device, a second latency cost for transmission of the data packet from the target device to the identified destination device via a backbone network, or a first path a total latency cost for transmission of the data packet from the originator device to the identified destination device via the target device;
the generating including generating the destination advertisement message based on the border router device determining the constraints required for the target device can be guaranteed by the border router device.

16. The method of claim 14, wherein the generating includes inserting at least one of a border router device identifier indicating the identified destination device is reachable via the border router device, first path metrics describing propagation characteristics of a path of the first message from the originator device to the border router device via a wireless network, or second path metrics describing propagation characteristics for the border router device reaching the identified destination device via a backbone network.

17. The method of claim 14, further comprising:
receiving a data packet originated by the originator device via the wireless data link and destined for the identified destination device; and
selectively forwarding the data packet to the identified destination device, via a backbone network, based on a determined absence of any other border router device in the backbone network having already forwarded the data packet to the identified destination device.

18. The method of claim 17, wherein the data packet is received via the wireless data link from a first wireless network device, the method further comprising:
receiving a copy of the data packet via a second wireless data link from a second wireless network device and destined for the identified destination device; and
dropping the copy of the data packet from transmission to the identified destination device, based on determining the data packet has already been forwarded to the identified destination device.

19. An apparatus providing reachability to an identified destination device, the apparatus comprising:
a device interface circuit configured for receiving, via a wireless data link, a first message requesting reachability to the identified destination device via an identified target device class; and
a processor circuit configured for generating, in response to the first message, a destination advertisement message in response to the apparatus, as a border router device, belonging to the target device class, the processor circuit further configured for causing the device interface circuit to output the destination advertisement message via the wireless data link for delivery to an originator device of the first message, the destination advertisement specifying the identified destination device is reachable.

20. The apparatus of claim 19, wherein:
the first message further specifies one or more constraints required for a target device of the target device class, including at least one of a first latency cost for transmission of a data packet from the originator device to the target device, a second latency cost for transmission of the data packet from the target device to the identified destination device via a backbone network, or a first path a total latency cost for transmission of the data packet from the originator device to the identified destination device via the target device;
the processor circuit configured for generating the destination advertisement message based on determining the constraints required for the target device can be guaranteed by the apparatus.

21. The apparatus of claim 19, wherein the processor circuit is configured for inserting, into the destination advertisement message, at least one of a border router device identifier indicating the identified destination device is reachable via the apparatus, first path metrics describing propagation characteristics of a path of the first message from the originator device to the apparatus via a wireless network, or second path metrics describing propagation characteristics for the apparatus reaching the identified destination device via a backbone network.

22. The apparatus of claim 19, wherein:
the device interface circuit is configured for receiving a data packet originated by the originator device via the wireless data link and destined for the identified destination device;
the processor circuit configured for selectively causing the device interface circuit to forward the data packet to the identified destination device, via a backbone network, based on a determined absence of any other border router device in the backbone network having already forwarded the data packet to the identified destination device.

23. The apparatus of claim 22, wherein:
the data packet is received by the device interface circuit via the wireless data link from a first wireless network device;
the device interface circuit further configured for receiving a copy of the data packet via a second wireless data link from a second wireless network device and destined for the identified destination device;
the processor circuit configured for dropping the copy of the data packet from transmission to the identified destination device, based on determining the data packet has already been forwarded to the identified destination device.

24. One or more non-transitory tangible media encoded with logic for execution by a machine and when executed by the machine operable for:
receiving, via a wireless data link by a border router device providing reachability to an identified destination device, a first message requesting reachability to the identified destination device via an identified target device class;
generating, by the border router device in response to the first message, a destination advertisement message in response to the border router device belonging to the target device class; and
outputting, by the border router device, the destination advertisement message via the wireless data link for delivery to an originator device of the first message, the destination advertisement specifying the identified destination device is reachable.
